(19) United States
(12) Patent Application Publication
(10) Pub. No.: US 2002/0034287 A1
(43) Pub. Date: Mar. 21, 2002

(54) Communication service connection processing apparatus

(75) Inventors: Kenji Takeda, Tokyo (JP); Tomoki Osawa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/998,544

(22) Filed: Nov. 29, 2001

Related U.S. Application Data
(63) Continuation of application No. 09/123,835, filed on Jul. 28, 1998.

(30) Foreign Application Priority Data
Jul. 28, 1997 (JP) 201680/1997

(51) Int. Cl. H04M 3/42

(52) U.S. Cl. 379/201.01

(57) ABSTRACT

A communication service connection processing apparatus receives a call setting request from an originating terminal unit with respect to a terminating terminal unit subscribing a plurality of communication service networks and having a plurality of terminal numbers, and performs call setting for a communication service network in which the terminating terminal unit is present. The apparatus includes a terminal number storage unit and a call processing unit. The terminal number storage unit stores, in advance, the plurality of terminal numbers of the terminating terminal unit. The call processing unit reads out the plurality of terminal numbers from the terminal number storage unit, simultaneously sends outgoing calls to the plurality of communication service networks, and connects the originating terminal unit to a communication service network from which an incoming call response is received.

### BACKGROUND OF THE INVENTION

1. Field of the Invention

The present invention relates a communication service connection processing apparatus and, more particularly, to a communication service connection processing apparatus which sends an outgoing call to a mobile terminal subscribing to a plurality of communication service networks and performs call connection processing for a communication service network in which the mobile terminal is present.

2. Description of the Prior Art

A mobile terminal subscribing a plurality of communication service networks has a terminal number for each communication service network. Consider transmission of an outgoing call to such a mobile station. If the communication service network in which the mobile terminal is present is known at the time of originating operation, an outgoing call is sent by using one of the terminal numbers of the mobile terminal which corresponds to the communication service network in which the terminal is present. If the communication service network in which the mobile terminal is present is unknown, an outgoing call is set by selecting one of the terminal numbers of the mobile terminal which correspond to the communication service networks to which the terminal subscribes. If no incoming call response is received within a predetermined period of time, it is determined that the mobile terminal is not present in this communication service network, and outgoing calls are sequentially sent by using the remaining terminal numbers until an incoming call response is received.

As described above, in the conventional system, in sending an outgoing call to a mobile terminal subscribing to a plurality of communication service networks and having a plurality of terminal numbers, if the communication service network in which the mobile terminal is present is unknown, and the terminal is not present in the communication service network to which the outgoing call is sent, outgoing calls are sequentially sent to the remaining service networks until an incoming call response is obtained. A long period of time is therefore required to perform call connection.

### SUMMARY OF THE INVENTION

The present invention has been made in consideration of the above situation in the prior art, and has as its object to provide a communication service connection processing apparatus which can quickly connect a mobile terminal subscribing to a plurality of communication service networks and having a plurality of terminal numbers to a communication service network in which a terminal is present when performing call connection processing for the mobile terminal.

In order to achieve the above object, according to the principal aspect of the present invention, there is provided a communication service connection processing apparatus which receives a call setting request from an originating terminal unit with respect to a terminating terminal unit subscribing a plurality of communication service networks and having a plurality of terminal numbers, and performs connection processing for a communication service network in which the terminating terminal unit is present, comprising terminal number storage means storing, in advance, the plurality of terminal numbers of the terminating terminal unit, and call processing means for reading out the plurality of terminal numbers from the terminal number storage means, simultaneously sending outgoing calls to the plurality of communication service networks, and connecting the originating terminal unit to a communication service network from which an incoming call response is received. The call processing means according to the principal aspect comprises a plurality of call setting sections which are arranged in correspondence with the plurality of communication service networks and send outgoing calls to the plurality of communication service networks and receive incoming call responses therefrom, a call control section for searching the terminal number storage means on the basis of one terminal number contained in a call setting request sent from the originating terminal unit, reading out a plurality of terminal numbers of the terminating terminal unit, and respectively assigning the terminal numbers to the plurality of call setting sections, and a call connection section for, when an incoming call response is received from any one of the plurality of call setting sections, connecting the originating terminal unit to a communication service network corresponding to the call setting section from which the incoming call response is received.

According to the present invention having the above aspects, the terminal numbers corresponding to the plurality of communication service networks to which the terminating unit subscribes are stored in advance. When a call setting request is received from the originating terminal unit, a plurality of terminal numbers are read out on the basis of one terminal number contained in the call setting request as a key, and outgoing calls are simultaneously sent to the plurality of communication service networks to which the terminating terminal unit subscribes. With this operation, the time required for call connection can be shortened even if the communication service network in which the terminating terminal unit is present is unknown.

The above and many other objects, features and advantages of the present invention will become manifest to those skilled in the art upon making reference to the following detailed description and accompanying drawings in which preferred embodiments incorporating the principles of the present invention are shown by way of illustrative examples.

### BRIEF DESCRIPTION OF THE DRAWINGS

FIG. 1 is a block diagram showing the arrangement of a communication service connection processing apparatus according to the first embodiment of the present invention;

FIG. 2 is a flow chart showing the operation of the first embodiment in FIG. 1;

FIG. 3 is a block diagram showing the arrangement of the second embodiment of the present invention; and

FIG. 4 is a flow chart showing the operation of the second embodiment in FIG. 3.

### DETAILED DESCRIPTION OF PREFERRED EMBODIMENTS

A few preferred embodiments of the present invention will be described below with reference to the accompanying drawings.

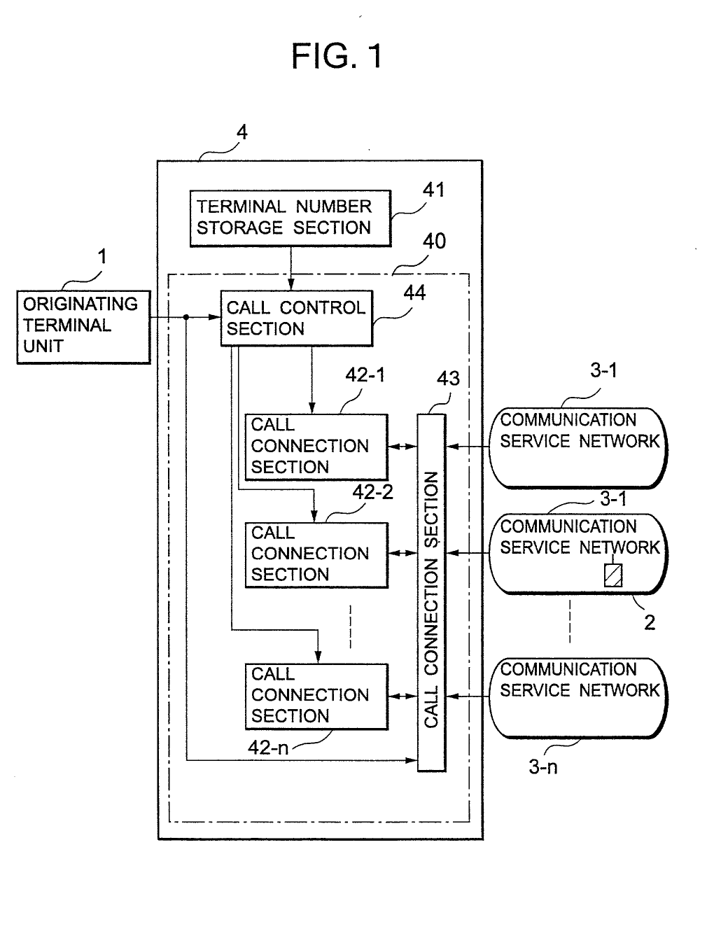

FIG. 1 is a block diagram showing the arrangement of the first embodiment of the present invention. In this embodiment, a communication service connection processing apparatus 4 is installed in an office or the like and connected to an originating terminal unit 1 and a plurality of communication service networks 3-1 to 3-n (n is an integer equal to or more than two). The originating terminal unit 1 is a terminal unit such as a telephone set or personal computer. The originating terminal unit 1 is connected to a terminating terminal unit 2 in a communication service network through the communication service connection processing apparatus 4.

The terminating terminal unit 2 is a mobile terminal having terminal numbers corresponding to a plurality of communication service networks. For example, the terminating terminal unit 2 is a portable telephone set having communication interfaces for a public PHS system network and an office cordless telephone system network or a portable information terminal unit having communication interfaces for PSTN or Ethernet. Assume that the terminating terminal unit 2 subscribes to all the communication service networks 3-1 to 3-n and has n terminal numbers. Assume also that in the following description, the terminating terminal unit 2 is present in the service area covered by the communication service network 3-2.

The communication service connection processing apparatus 4 includes a terminal number storage section 41 storing, in advance, the terminal numbers of the terminating terminal unit 2 which correspond to a plurality of communication service networks to which the terminal subscribes, and a call processing unit 40 for reading out a plurality of terminal numbers from the terminal number storage section 41, simultaneously sending outgoing calls to a plurality of communication service networks, and connecting the originating terminal unit 1 to the communication service network from which an incoming call response is received.

The call processing unit 40 includes n call setting sections 42-1 to 42-n arranged in correspondence with the communication service networks 3-1 to 3-n to perform call setting, a call connection section 43 for connecting the originating terminal unit 1 to one of the communication service networks 3-1 to 3-n, and a call control section 44 for instructing the call setting sections 42-1 to 42-n to perform call setting in response to the call setting request from the originating terminal unit 1.

The operation of the first embodiment will be described next.

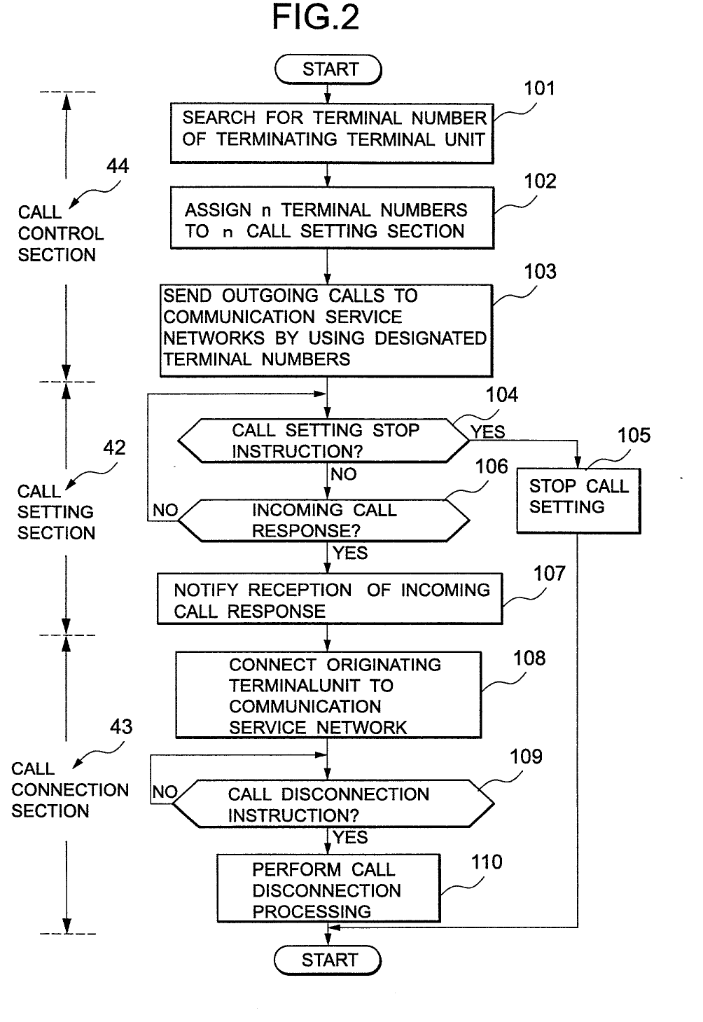

FIG. 2 is a flow chart showing the operation of the communication service connection processing apparatus 4 in FIG. 1. Upon reception of a call setting request sent from the originating terminal unit 1, the call control section 44 of the communication service connection processing apparatus 4 starts the operation.

When the originating terminal unit 1 outputs a call setting request for the terminating terminal unit 2, the originating terminal unit 1 designates arbitrary one of the n terminal numbers of the terminating terminal unit 2.

Upon reception of the call setting request sent from the originating terminal unit 1, the call control section 44 of the communication service connection processing apparatus 4 starts the operation. First of all, the call control section 44 searches the terminal number storage section 41 with the terminal number contained in the call setting request as a key, and reads out the n−1 remaining terminal numbers of the terminating terminal unit 2 (step 101). The call control section 44 then assigns the n terminal numbers to the call setting sections 42-1 to 42-n corresponding to the communication service networks 3-1 to 3-n (step 102). The call setting sections 42-1 to 42-n respectively send outgoing calls to the communication service networks 3-1 to 3-n by using the terminal numbers designated by the call control section 44 (step 103).

Upon reception of a disconnection request from the originating terminal unit 1, the call control section 44 immediately outputs a call setting stop instruction to the call setting sections 42-1 to 42-n. Upon reception of the call setting stop instruction (step 104), the call setting sections 42-1 to 42-n immediately stop call setting (step 105).

When the call setting section 42-2 receives an incoming call response from the terminating terminal unit 2 in the communication service network 3-2 through the call connection section 43 afterward (step 106), the call setting section 42-2 notifies the call connection section 43 of the reception of the incoming call response (step 107).

Upon reception of the notification of the reception of the incoming call response from any one of the call setting sections, i.e., the call setting section 42-2, the call connection section 43 connects the communication service network 3-2 corresponding to the call setting section 42-2 to the originating terminal unit 1 (step 108). With this operation, the originating terminal unit 1 is connected to the terminating terminal unit 2.

Upon reception of a disconnection request from the originating terminal unit 1 afterward, the call control section 44 outputs a call disconnection instruction to the call setting sections 42-1 to 42-n (step 108). Upon reception of the call disconnection instruction, the call setting sections 42-1 to 42-n immediately notify the call connection section 43 of call disconnection. Upon reception of the notification of call disconnection (step 109), the call connection section 43 performs all disconnection processing (step 110).

Assume that the communication service connection processing apparatus 4 is a constituent of an office cordless telephone system network, and the terminating terminal unit 2 has communication interfaces for this office cordless telephone system network and a public PHS system network and two terminal numbers “1000” and “030-1234567”. In this case, at least the terminal numbers “1000” and “030-1234567” are stored in the terminal number storage means 41 in advance. Assume also that the call setting section 42-1 is connected to the office cordless telephone system network 3-1, and the call setting section 42-2 is connected to the public PHS system network 3-2.

When the originating terminal unit 1 is to send an outgoing call to the terminating terminal unit 2, the originating terminal unit 1 generates a call setting request by designating arbitrary one of the two terminal numbers of the terminating terminal unit 2, e.g., “1000”. In this case, the call control section 44 of the communication service connection processing apparatus 4 searches the terminal number storage section 41 with the terminal number “1000” as a key and reads out the other terminal number “030-1234567” of the terminating terminal unit 2. The call control section 44 then respectively designates the terminal numbers “1000” and “030-1234567” for the call setting sections 42-1 and 42-2, thereby causing them to execute call setting.

If the terminating terminal unit 2 is present in the service area covered by the public PHS system network 3-2 at the time of originating operation, the terminating terminal unit 2 receives the call signal based on the terminal number “030-1234567” corresponding to the public PHS system network 3-2, and outputs an incoming call response. The incoming call from the terminating terminal unit 2 is input to and detected by the call setting section 42-2 through the public PHS system network 3-2 and the call connection section 43. The call setting section 42-2 then notifies the call connection section 43 of the reception of the incoming call response. As a result, the call connection section 43 connects the public PHS system network 3-2, in which the terminating terminal unit 2 is present, to the originating terminal unit 1. Since outgoing calls are simultaneously sent to a plurality of communication service networks to which the terminating terminal unit 2 subscribes in this manner, the time required for call connection can be shortened.

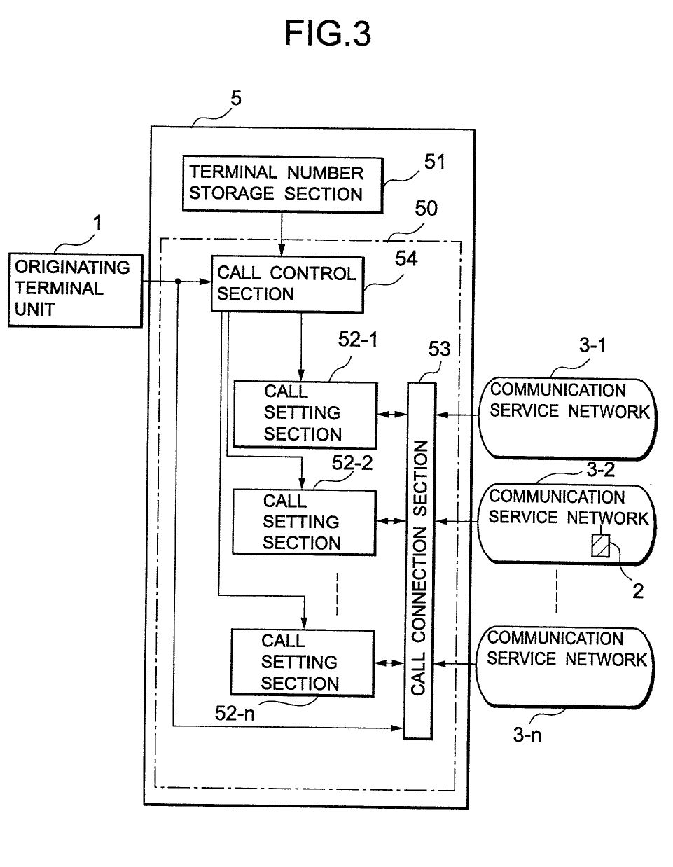

FIG. 3 is a block diagram showing the arrangement of the second embodiment of the present invention.

This embodiment differs from the communication service connection processing apparatus 4 shown in FIG. 1 in that a call control section 54 of a call processing means 50 controls a call connection section 53. An originating terminal unit 1, a terminating terminal unit 2, and communication service networks 3-1 to 3-n (n is an integer equal to or larger than two) are identical to those shown in FIG. 1.

Referring to FIG. 3, a communication service connection processing apparatus 5 includes a terminal number storage section 51 storing, in advance, the terminal numbers of the terminating terminal unit 2 which correspond to a plurality of communication service networks to which the terminating terminal unit 2 subscribes, and the call processing unit 50 for reading out a plurality of terminal numbers from the terminal number storage section 51, simultaneously sending outgoing calls to a plurality of communication service networks, and connecting the originating terminal unit 1 to the communication service network from which an incoming call response is received.

The call processing unit 50 includes call setting sections 52-1 to 52-n arranged in correspondence with the communication service networks 3-1 to 3-n to perform call setting, the call connection section 53 for connecting the originating terminal unit 1 to one of the communication service networks 3-1 to 3-n, and the call control section 54 for controlling the call setting sections 52-1 to 52-n and the call control section 54.

Upon reception of the call setting request sent from the originating terminal unit 1, the call control section 54 searches the terminal number storage section 51 with the terminal number contained in this call setting request as a key and reads out corresponding data. The call control section 54 respectively assigns the terminal numbers to the call setting sections 52-1 to 52-n arranged in correspondence with the communication service networks to which the terminating terminal unit 2 subscribes, and instructs them to execute call setting. In addition, the call control section 54 causes the call connection section 53 to connect the call setting sections 52-1 to 52-n to the communication service networks 3-1 to 3-n, respectively.

The call setting sections 52-1 to 52-n respectively send outgoing calls to the communication service networks through the call connection section 53 on the basis of the terminal numbers assigned by the call control section 54. When the terminating terminal unit 2 returns an incoming call response afterward, one of the call setting sections 52-1 to 52-n receives, through the call connection section 53, an incoming call response signal from the communication service network in which the terminating terminal unit 2 is present, and notifies the call control section 54 of the reception of the incoming call response.

If the call control section 54 receives a disconnection request from the originating terminal unit 1 before receiving the incoming call response from one of the call setting sections 52-1 to 52-n, the call control section 54 immediately instructs the call setting sections 52-1 to 52-n to stop call setting. Upon reception of the incoming call response from any one of the call setting sections 52-1 to 52-n, the call control section 54 instructs the call connection section 53 to connect the originating terminal unit 1 to the communication service network from which the incoming call response is received, and at the same time, instructs the remaining call setting sections to stop call setting.

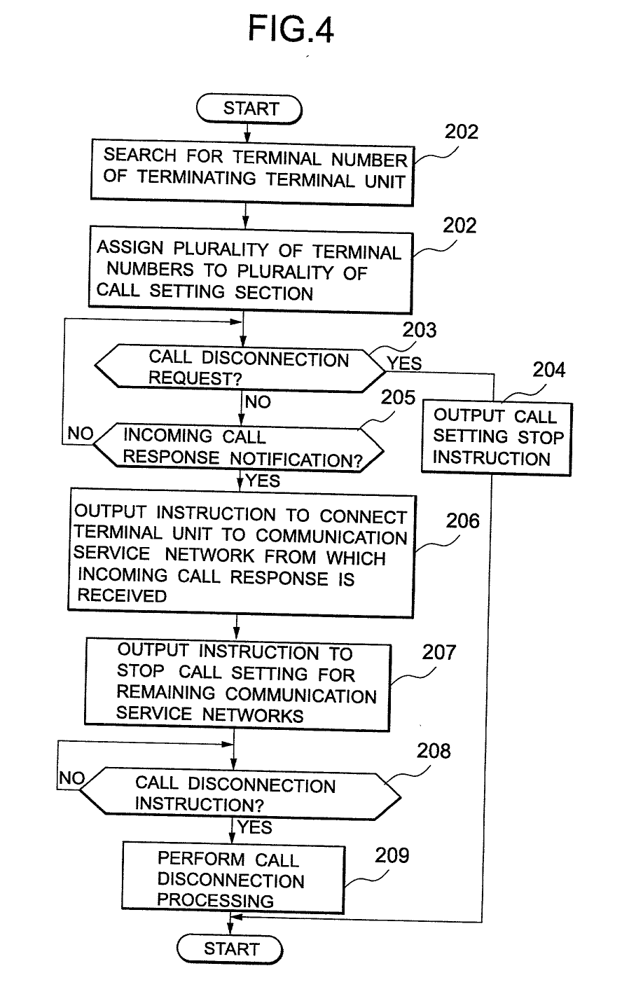

FIG. 4 is a flow chart showing the operation of the call control section 54 in the second embodiment of the present invention.

Upon reception of a call setting request from the originating terminal unit 1, the call control section 54 searches the terminal number storage means 51 with the terminal number contained in the call setting request as a key, and reads out the plurality of terminal numbers of the terminating terminal unit 2 (step 201). The call control section 54 then respectively assigns the terminal numbers to the call setting sections 52-1 to 52-n corresponding to the communication service networks corresponding to the plurality of terminal numbers, and causes them to execute call setting (step 202).

If the call control section 54 receives a disconnection request from the originating terminal unit 1 before receiving an incoming call response notification from one of the call setting sections 52-1 to 52-n (step 203), the call control section 54 immediately instructs the call setting sections 52-1 to 52-n to stop call setting (step 204). If the call control section 54 receives an incoming call response notification from any one of the call setting sections 52-1 to 52-n (step 205), the call control section 54 instructs the call connection section 53 to connect the originating terminal unit 1 to the communication service network corresponding to the call setting section from which the incoming call response notification is received (step 206). At the same time, the call control section 54 instructs the remaining call setting sections to stop call setting (step 207).

Upon reception of a disconnection request from the originating terminal unit 1 afterward (step 208), the call control section 54 outputs a call disconnection instruction to the call setting sections 52-1 to 52-n and the call connection section 53 (step 209).

What is claimed is:

1. A communication service connection processing apparatus which receives a call setting request from an originating terminal unit with respect to a terminating terminal unit subscribing a plurality of communication service networks and having a plurality of terminal numbers, and performs call connection processing for a communication service network in which said terminating terminal unit is present, comprising terminal number storage means storing, in advance, the plurality of terminal numbers of said terminating terminal unit, and call processing means for reading out the plurality of terminal numbers from said terminal number storage means, simultaneously sending outgoing calls to the plurality of communication service networks, and connecting said originating terminal unit to a communication service network from which an incoming call response is received.

2. An apparatus according to claim 1, wherein upon reception of an incoming call response from any one of the plurality of communication service networks, said call processing means stops processing for the remaining communication service networks.

3. An apparatus according to claim 2, wherein said call processing means comprises a plurality of call setting sections which are arranged in correspondence with the plurality of communication service networks and send outgoing calls to the plurality of communication service networks and receive incoming call responses therefrom.

4. An apparatus according to claim 3, wherein said call processing means comprises a call control section for searching said terminal number storage means on the basis of one terminal number contained in a call setting request sent from said originating terminal unit, reading out a plurality of terminal numbers of said terminating terminal unit, and respectively assigning the terminal numbers to said plurality of call setting sections.

5. An apparatus according to claim 4, wherein said call processing means comprises a call connection section for, when an incoming call response is received from any one of said plurality of call setting sections, connecting said originating terminal unit to a communication service network corresponding to said call setting section from which the incoming call response is received.

6. An apparatus according to claim 5, wherein said call control section receives notification of the incoming call response from each of said plurality of call setting sections, and controls operations of said plurality of call setting sections and said call connection section.
